(19) United States
(12) Patent Application Publication
(10) Pub. No.: US 2026/0219723 A1
(43) Pub. Date: Jul. 30, 2026

(54) SYSTEM-ON-CHIP DEVICE

(71) Applicant: ITDA SEMICONDUCTOR CO., LTD., Hwaseong-si, Gyeonggi-do (KR)

(72) Inventors: Hoyeon JEON, Seongnam-si (KR); Ahchan KIM, Hwaseong-si (KR); Ingyu KIM, Hwaseong-si (KR)

(73) Assignee: ITDA SEMICONDUCTOR CO., LTD., Hwaseong-si, Gyeonggi-do (KR)

(21) Appl. No.: 19/142,041

(22) PCT Filed: Oct. 30, 2023
(86) PCT No.: PCT/KR2023/016995

§ 371 Date: Jun. 20, 2025

(30) Foreign Application Priority Data
Jan. 2, 2023 (KR) 10-2023-0000430

(51) Int. Cl. G06F 1/3234

(52) U.S. Cl. CPC G06F 1/3275; G06F 1/3243

(57) ABSTRACT

A system-on-chip (SoC) device is disclosed. According to the disclosure, the system-on-chip device comprises at least one power domain; and at least one power management unit (PMU) respectively corresponding to and controlling the at least one power domain, wherein the power management unit comprises a first region configured to perform processing and control, and a second region configured to physically transmit signals, and the first region and the second region are independently separated and respectively present in different components of the system-on-chip device.

### TECHNICAL FIELD

The present disclosure relates to a system-on-chip (SoC) device, and more particularly, to a system-on-chip device in which a microcontroller unit for controlling power domains is configured in a clustered form within a specific region.

### BACKGROUND ART

There are design methods for a controller that handles a system-on-chip (SoC) power up/down sequence, including a method using a state machine and a method using a microcontroller unit (MCU).

In the past, when the complexity of SoCs was low and the power up/down sequence was simple, a power controller was mainly designed using a state machine. While a state machine has the advantage of being small and fast, it has the disadvantage of lacking flexibility because it can only execute predefined sequences.

Accordingly, as SoCs become increasingly complex and power up/down sequences become more complicated, it is becoming mainstream to design power controllers using highly flexible MCUs in order to flexibly cope with various abnormal cases that occur at the actual silicon level.

### PRIOR ART DOCUMENT

(Patent Document 1) Korean Registered Patent No. 10-2301639 (Sep. 7, 2021)

### DETAILED DESCRIPTION OF INVENTION

### Technical Problems

An object to be achieved by the present disclosure is to provide a system-on-chip device in which a power management unit for controlling power domains is configured in a form in which it is entirely clustered within a specific region of the SoC.

### Technical Solution

According to an embodiment of the present disclosure, a system-on-chip (SoC) device comprises: at least one power domain; and at least one power management unit (PMU) respectively corresponding to and controlling the at least one power domain, wherein the power management unit comprises a first region configured to perform processing and control, and a second region configured to physically transmit signals, and wherein the first region and the second region are independently separated and respectively present in different components of the system-on-chip device.

In the system-on-chip device, at least one first region is respectively present corresponding to each of the at least one power management unit, and the at least one first region may be present in a clustered form within a specific region of the system-on-chip device, excluding the at least one power domain.

In the system-on-chip device, a first power domain that remains active when the system-on-chip device is operating may be further included, the at least one power domain may be a second power domain that is selectively activatable when the system-on-chip device is operating, and the at least one first region may be present in a clustered form within the first power domain.

In the system-on-chip device, the first power domain may further include a power system manager (PSM), an internal bus, test logic, and memory.

In the system-on-chip device, at least one second region is respectively present corresponding to each of the at least one power management unit, and the at least one second region may be present corresponding to a non-power gating region of the at least one power domain within the system-on-chip device.

In the system-on-chip device, the first region is a power domain manager (PDM), which is a microcontroller unit (MCU) configured to control the corresponding power domain, and the second region is a power operating unit (POU).

In the system-on-chip device, a plurality of sub-system-on-chip devices hierarchically existing at a lower level may be further included, each of the plurality of sub-system-on-chip devices includes a plurality of power domains, a plurality of first regions respectively corresponding to and controlling the plurality of power domains may be present in a clustered form within specific regions excluding the plurality of power domains in each of the plurality of sub-system-on-chip devices, and the plurality of first regions in a clustered form may be respectively present corresponding to each of the plurality of sub-system-on-chip devices.

In the system-on-chip device, a memory may be further included, at least one first region is respectively present corresponding to each of the at least one power management unit, and the memory may be partitioned by address and may allocate independent address regions respectively corresponding to each of the at least one first region.

In the system-on-chip device, when a program to be executed by the at least one first region is the same, the program may be shared and used in a predetermined address region of the memory.

### Effect of Invention

According to embodiments of the present disclosure, by configuring a form in which PDMs are clustered in a specific region of the SoC, it is possible to simplify and enhance the efficiency of the SoC structure.

In addition, according to embodiments of the present disclosure, instead of placing a small-sized MCU for controlling each power domain in each power domain, it is possible to reduce the area of the SoC by creating a single large-sized memory instance.

### BRIEF DESCRIPTION OF THE DRAWING

FIG. 1 is a diagram illustrating a structure in which a power controller for a power domain is located within the corresponding power domain according to the present disclosure.

FIG. 2 is a diagram illustrating in detail an internal structure of a sub PMU within a power domain in FIG. 1.

FIG. 3 is a block diagram illustrating a configuration of a system-on-chip (SoC) device according to the present disclosure.

FIG. 4 is a diagram illustrating a detailed layout structure of a power management unit included in a system-on-chip (SoC) device according to an embodiment of the present disclosure.

FIG. 5 is a diagram illustrating a detailed layout structure of a power management unit included in a system-on-chip (SoC) device according to another embodiment of the present disclosure.

FIGS. 6A and 6B are diagrams illustrating a memory structure included in a system-on-chip (SoC) device according to another embodiment of the present disclosure.

FIG. 7 is a diagram illustrating a computing device according to an embodiment of the present disclosure.

### DESCRIPTION OF REFERENCE NUMERALS

100, 300, 400, 500: system-on-chip (SoC) device
110, 430: PD_AON
115, 320, 435: power management unit (PMU)
116, 436: power system manager (PSM)
117, 229, 439: memory
118, 225, 437: internal bus
210, 422_A, 422_B, 422_C, 621, 622, 623, 624, 661, 662, 663, 664: power domain manager (PDM)
221: control interface
223: power control signals
227, 438: test logic
322: first region
324: second region
415_A, 415_B, 415_C: non-power gating region
424_A, 424_B, 424_C: power operating unit (POU)
501, 502, 503: sub-system
611, 612, 613, 614: memory space
651: specific region

### BEST MODE FOR CARRYING OUT THE INVENTION

Hereinafter, embodiments of the present disclosure will be described in detail with reference to the accompanying drawings, so that those skilled in the art can easily implement the present disclosure. However, the present disclosure may be implemented in various different forms and is not limited to the embodiments described herein. And, in the drawings, in order to clearly illustrate the present disclosure, portions unrelated to the description have been omitted, and similar reference numerals are used for similar elements throughout the entire specification.

In this specification, redundant descriptions of identical components will be omitted.

In addition, in this specification, when it is stated that a certain component is “connected to” or “coupled to” another component, it should be understood that the component may be directly connected or coupled to the other component or may have another component in between. On the other hand, in this specification, when it is stated that a certain component is “directly connected to” or “directly coupled to” another component, it should be understood that there is no intervening component in between.

In addition, the terms used in this specification are merely used to describe specific embodiments and are not intended to limit the present disclosure.

In addition, in this specification, the singular expressions may include the plural expressions unless the context clearly indicates otherwise.

In addition, in this specification, terms such as “include” or “have” are intended to specify that features, numbers, steps, operations, components, parts, or combinations thereof described in the specification exist, and should be understood as not precluding the possibility that one or more other features, numbers, steps, operations, components, parts, or combinations thereof may exist or be added.

In addition, in this specification, the term “and/or” includes a combination of a plurality of listed items or any one of the plurality of listed items. In this specification, “A or B” may include “A,” “B,” or both “A and B.”

In addition, in this specification, detailed descriptions of well-known functions and configurations that may obscure the essence of the present disclosure will be omitted.

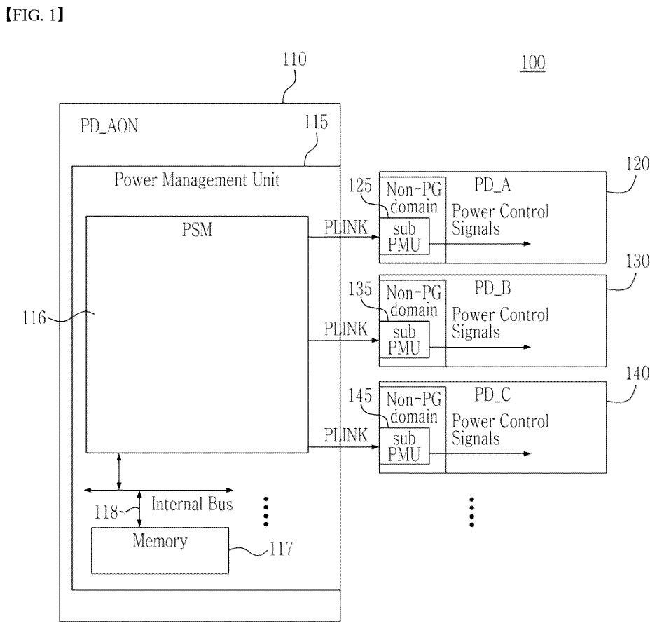

FIG. 1 is a diagram illustrating a structure in which a power controller for a power domain is located within the corresponding power domain according to the present disclosure.

Referring to FIG. 1, a system-on-chip (SoC) device 100 according to the present disclosure may be configured to include an always-on power domain (PD_AON) 110 and a plurality of power domains 120, 130, and 140.

The always-on power domain (PD_AON) 110 controls the power of the system-on-chip (SoC) device 100 and includes a power management unit (PMU) 115 for this purpose. The power management unit (PMU) 115 includes a power system manager (PSM) 116, a memory 117, an internal bus 118, and the like.

The plurality of power domains (PDs) 120, 130, and 140 include power domain A (PD_A) 120, power domain B (PD_B) 130, and power domain C (PD_C) 140. In this case, each of the power domains 120, 130, and 140 includes a sub power management unit (sub PMU) 125, 135, and 145 in a non-power gating (Non-PG) region of the corresponding power domain. Here, the sub PMUs 125, 135, and 145 may be microcontroller units (MCUs) for power control. Specifically, power domain A (PD_A) 120 includes the sub PMU 125 in its non-power gating region, power domain B (PD_B) 130 includes the sub PMU 135 in its non-power gating region, and power domain C (PD_C) 140 includes the sub PMU 145 in its non-power gating region.

In order for an MCU to operate, a memory for storing instructions and data is essential. In addition, if a memory is present, a bus interface for downloading a program to the memory and BIST (Built-In Self-Test) logic insertion for testing the memory are also required accordingly.

As shown in FIG. 1, if a power controller for a certain power domain must be located within the corresponding power domain, it must necessarily be located in a non-power gating region of that power domain. When an MCU for power control is present in this region, additional hardware—including a memory required for MCU operation, a bus interface, and BIST logic insertion—must also be included. As a result, the non-power gating region increases in size, the top routing increases, and additional power may be required for the memory, which leads to inefficiency in various aspects.

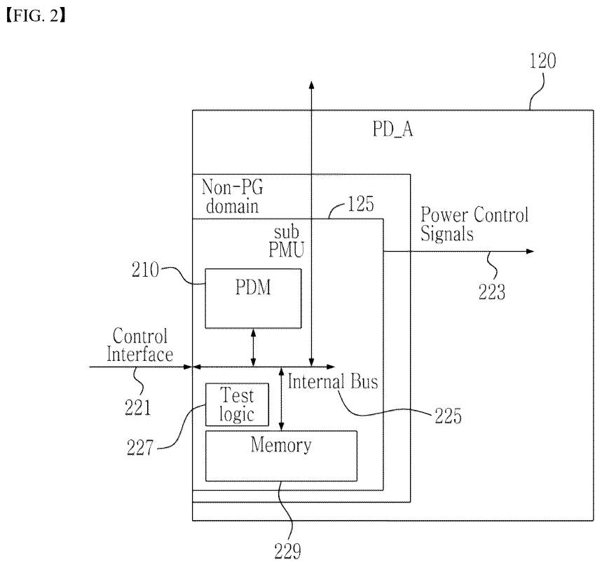

FIG. 2 is a diagram illustrating in detail an internal structure of a sub PMU within a power domain shown in FIG. 1.

Specifically, FIG. 2 illustrates a detailed internal structure of power domain A (PD_A) 120. In the non-power gating (Non-PG) domain inside power domain A (PD_A) 120, a sub power management unit (sub PMU) 125 that controls the power domain A (PD_A) 120 is present. The sub PMU 125 includes a power domain manager (PDM) 210, a control interface 221, power control signals 223, an internal bus 225, test logic 227, and a memory 229.

As described above, all logic required to control the power domain (PD) exists in the non-power gating (Non-PG) domain. Specifically, in the non-power gating domain, various components must be included, such as a power domain manager (PDM) 210 for actual power sequence control, a memory 229 used by the PDM 210, BIST logic for testing the memory 229, various interfaces 221 for these, and test logic 227 for controlling how the power control signals 223 are handled in the test mode.

Such a configuration inevitably increases design complexity, causes the non-power gating region to continuously increase, and requires a large number of signals for essential control interfaces and bus interfaces, thereby also increasing area overhead.

In addition, the MCU (in FIG. 2, PDM 210) that controls each power domain performs only small and simple instructions, and although the size of the memory required for this purpose is a small size within 1K, it is very inefficient in terms of memory management to create multiple instances of such small memory and have them separately distributed across multiple power domains.

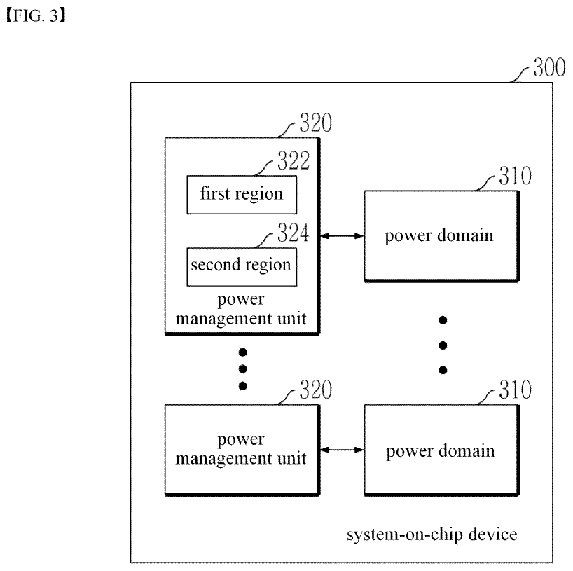

FIG. 3 is a block diagram illustrating a configuration of a system-on-chip (SoC) device according to the present disclosure.

A system-on-chip (SoC) device 300 according to the present disclosure is one in which a fully operable product and system are contained in a single integrated circuit, and may be implemented as a chip, module, or system.

The system-on-chip (SoC) device 300 according to the present disclosure may be configured to include a power domain 310 and a power management unit 320.

The power domain 310 may process a power up sequence and a power down sequence of the system-on-chip (SoC) device 300.

The system-on-chip (SoC) device 300 may include at least one power domain 310.

A power management unit (PMU) 320 may be configured to individually control at least one corresponding power domain 310. To this end, the system-on-chip (SoC) device 300 may include at least one power management unit 320.

Specifically, the power management unit 320 may be configured to include a first region 322 responsible for processing and control, and a second region 324 that physically delivers signals. In this case, the first region 322 and the second region 324 may be independently separated and may respectively exist in different components of the system-on-chip (SoC) device 300.

Referring to FIG. 3, the power management unit 320 includes a first region 322 and a second region 324. However, this merely conceptually illustrates the configuration of the power management unit 320 in the form of a block diagram, and it should be noted that the arrangement or structure of the first region 322 and the second region 324 within the actual system-on-chip device 300 may be implemented in various ways. For example, although the first region 322 and the second region 324 both constitute the power management unit 320, as described above, they may be independently separated and arranged in different components of the system-on-chip device 300.

At least one first region 322 may be present corresponding to each of the at least one power management units 320. In one example, the first region 322 may be a power domain manager (PDM), which is a microcontroller unit (MCU) that controls the corresponding power domain 310.

At least one first region 322 may be present in a clustered form in a specific region of the system-on-chip device 300, excluding the at least one power domain 310.

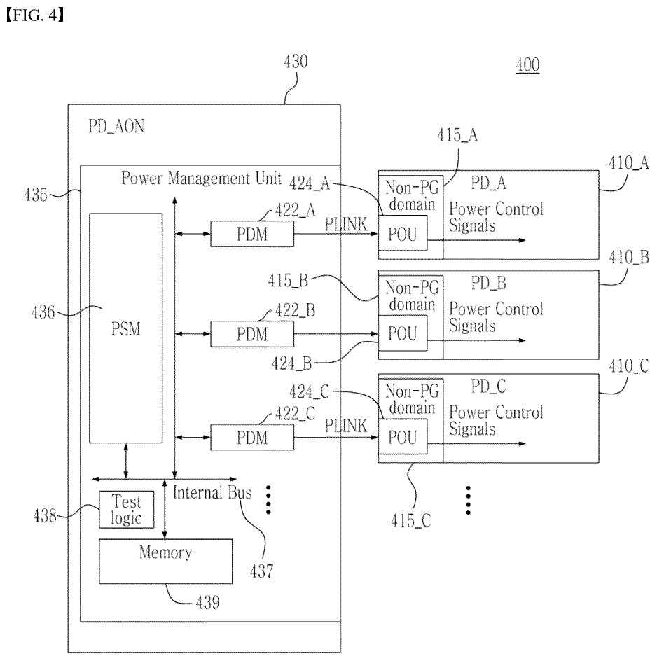

According to one embodiment, at least one first region 322 may be present in a clustered form in PD_AON (always-on power domain). Specifically, the system-on-chip device 300 may further include a first power domain 430 in FIG. 4, which is always active when the system-on-chip device 300 operates. Here, the first power domain 430 may be PD_AON. In addition, at least one power domain 310 may be a second power domain that is selectively activatable when the system-on-chip device 300 operates. In this case, at least one first region 322 may be present in a clustered form in the first power domain 430.

The first power domain 430 in FIG. 4 may further include a power system manager (PSM), an internal bus, test logic, and memory.

At least one second region 324 may be present, each corresponding to a respective one of the at least one power management units 320. In one example, the second region 324 may be a power operating unit (POU).

At least one second region 324 may be present, each corresponding to one of the non-power gating regions 415_A, 415_B, and 415_C in FIG. 4 of at least one power domain 310 in the system-on-chip device 300.

According to an embodiment, the system-on-chip device 300 may be configured in a hierarchical structure, and power domain managers (PDMs) for controlling power domains may be present in a clustered form for each subsystem. Specifically, the system-on-chip device 300 may further include a plurality of sub-system-on-chip devices arranged hierarchically at a lower level, and each of the plurality of sub-system-on-chip devices may include a plurality of power domains 310. In this case, a plurality of first regions 322, each respectively corresponding to and controlling one of the plurality of power domains 310, may be present in a clustered form in a specific region other than the plurality of power domains 310 within each of the plurality of sub-system-on-chip devices, and the clustered plurality of first regions 322 may respectively correspond to the plurality of sub-system-on-chip devices.

Meanwhile, the system-on-chip device 300 may further include a memory (not shown). At least one first region 322 may be present corresponding to each of the at least one power management units. In this case, the memory (not shown) may be partitioned by address and may allocate independent address regions to the at least one first region 322, respectively. According to one embodiment, if the programs to be executed by the at least one first region 322 are the same, the program may be shared and used from a predetermined address region of the memory (not shown).

FIG. 4 is a diagram illustrating a detailed layout structure of a power management unit included in a system-on-chip (SoC) device according to an embodiment of the present disclosure.

A system-on-chip device 400 according to an embodiment of the present disclosure may be configured to include PD_AON 430 and a plurality of power domains 410_A, 410_B, and 410_C.

PD_AON (always-on power domain) 430 controls the power of the system-on-chip (SoC) device 400 and includes a power management unit (PMU) 435 for this purpose. The power management unit 435 includes a plurality of power domain managers (PDMs) 422_A, 422_B, and 422_C, each respectively corresponding to and controlling one of the plurality of power domains 410_A, 410_B, and 410_C. Within the power management unit (PMU) 435, there exist a power system manager (PSM) 436, an internal bus 437, test logic 438, memory 439, and the like. Here, the power system manager 436 controls and manages the power of the system-on-chip device 400. The memory 439 stores instructions and data for operating the plurality of PDMs 422_A, 422_B, and 422_C. The internal bus 437 downloads programs to the memory 439. In addition, the test logic 438 tests the memory 439.

The plurality of power domains 410_A, 410_B, and 410_C includes a power domain A (PD_A) 410_A, a power domain B (PD_B) 410_B, and a power domain C (PD_C) 410_C. In this case, each of the plurality of power domains 410_A, 410_B, and 410_C includes a power operating unit (POU) 424_A, 424_B, and 424_C in a non-power gating region 415_A, 415_B, and 415_C of the corresponding power domain. Here, the POUs 424_A, 424_B, and 424_C may be regions for physically transmitting signals. Specifically, the power domain A (PD_A) 410_A includes the POU 424_A in the non-power gating region 415_A, the power domain B (PD_B) 410_B includes the POU 424_B in the non-power gating region 415_B, and the power domain C (PD_C) 410_C includes the POU 424_C in the non-power gating region 415_C.

According to the system-on-chip device 400 of an embodiment of the present disclosure, which is configured as described above, the power management unit (PMU) for controlling a specific power domain does not exist within the corresponding power domain but has a clustered structure in a specific region of the SoC 400.

The most significant difference between the structure proposed in the present disclosure and the conventional structure is that the power management unit (PMU) required to control a power domain is independently configured by separating it into a part responsible for actual processing and control (PDM in FIG. 4) and a part that physically transmits signals (POU in FIG. 4). Specifically, various complex parts of the PMU are all related to the PDM, and this part is configured in a clustered form in a specific region inside the SoC, rather than in the power domain. In addition, only the part where signals are physically transmitted for each power domain is configured to be present in the non-power gating domain of each power domain.

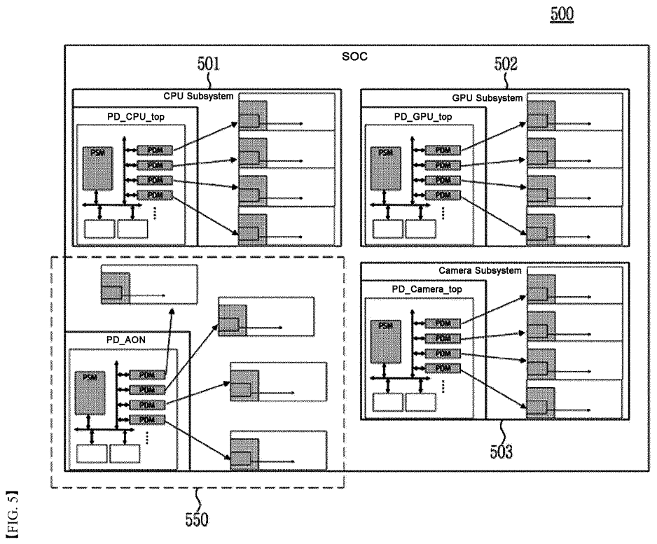

FIG. 5 is a diagram illustrating a detailed layout structure of a power management unit included in a system-on-chip (SoC) device according to another embodiment of the present disclosure.

A structure in which only the PDM-related parts, which are the complex parts responsible for processing and control in the power management unit, are arranged in a clustered form in a specific region of the SoC rather than in the power domain, is more scalable depending on the SoC structure. In this case, the clustered PDMs do not exist as only one in a single specific region of the SoC, but multiple clustered PDMs may exist for each of multiple subsystems, depending on the SoC structure.

That is, although a structure in which multiple power domains exist in a flattened manner under the SoC may be adopted, in more complex SoCs, instead of being configured in a flattened manner, the structure may be configured such that multiple subsystems (i.e., sub-SoCs) exist hierarchically under the SoC, and multiple power domains exist under each of the subsystems.

Referring to FIG. 5, an example is shown in which a CPU subsystem 501, a GPU subsystem 502, and a camera subsystem 503 exist under the SoC 500, and multiple power domains exist under each of the subsystems. In this case, the clustered PDMs may be configured to exist for each of the subsystems 501, 502, and 503. Since the architecture in which subsystems exist under the SoC 500 implies that the functional features of the SoC are handled hierarchically, there is a high likelihood that power management is also desired to be configured accordingly.

However, according to an embodiment, the system-on-chip (SoC) may be configured to include only one clustered PDM for the entire SoC, regardless of the division of subsystems. The design of such a placement structure may vary depending on software operation policies or the like.

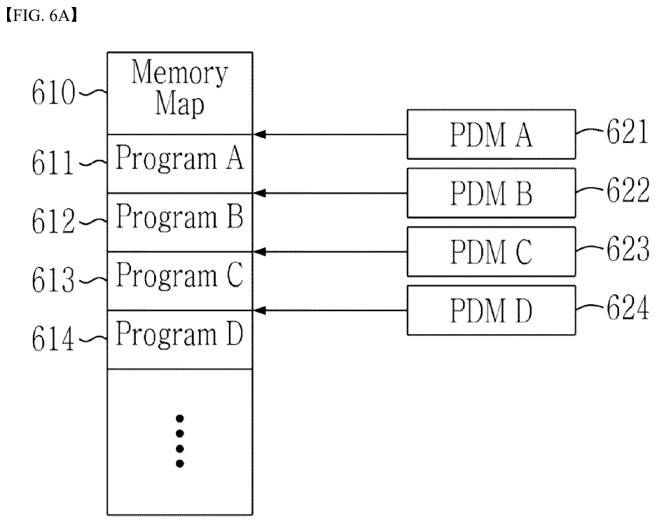

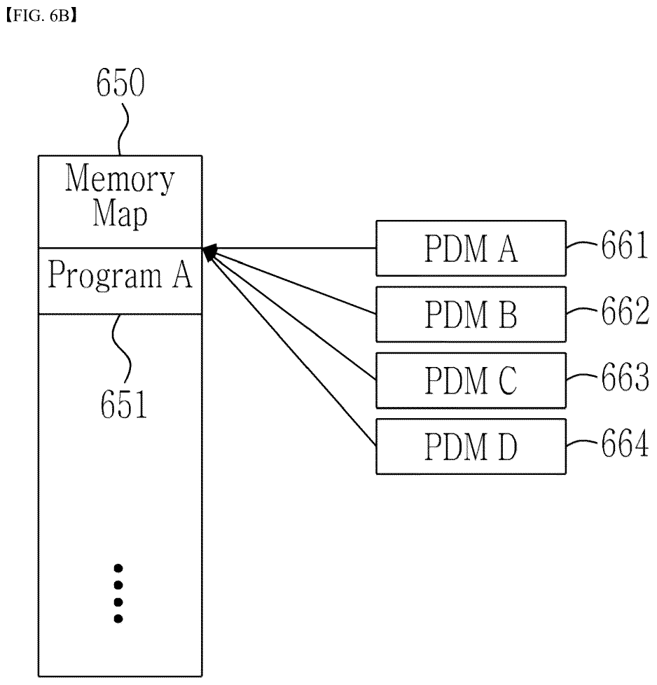

FIGS. 6A and 6B are diagrams illustrating a memory structure included in a system-on-chip (SoC) device according to another embodiment of the present disclosure.

For a single memory, it is possible to divide it into sections according to addresses, and to assign an independent address range to each MCU for use.

In addition, to operate power management and control more efficiently, when the programs to be executed by multiple MCUs are the same, the memory of the same address range may be shared by the multiple MCUs.

In FIG. 6A, when the programs that four PDMs 621, 622, 623, and 624 need to use are all different, each of the PDMs 621, 622, 623, and 624 must occupy a corresponding allocated memory space 611, 612, 613, and 614 for each program (Program A, Program B, Program C, and Program D) used, respectively. In this case, memory spaces 611, 612, 613, and 614 are occupied in the same number as the PDMs 621, 622, 623, and 624.

However, as shown in FIG. 6B, when the programs used by the four PDMs 661, 662, 663, and 664 are the same (that is, all use Program A), instead of storing the same program in all four locations, Program A may be stored only in one specific region 651 and shared by all the PDMs 661, 662, 663, and 664. As a result, the required memory size is reduced.

The SoC structure proposed in the present disclosure can flexibly respond in any situation to construct a power management structure that meets the requirements of the SoC.

The proposed structure has the following advantages.

First, simplification and efficiency of the structure. The clustered PDMs are mainly located together in a specific region of the SoC, preferably in the Always-On Domain (AON). With such a structure, instead of having each power domain possess its own memory, its own bus interface, and its own test logic, multiple MCUs can be grouped in one place and share a single memory, a single bus, and a single test logic, thereby achieving a much simpler and more efficient structure.

Second, reduction of area. The MCU (PDM in FIG. 4) that controls each power domain performs only small and simple instructions, and the required memory size is very small, within 1K. Instead of creating dozens of such small memory instances and placing them in each power domain, creating a single large-sized memory instance may result in a smaller total area.

Third, it is efficient in terms of the roles and responsibilities in SoC design. In most complex SoCs, the design process is carried out in such a way that multiple designers are each responsible for designing their respective power domains, and most of these designers are experts in the functional features of their assigned blocks but lack domain knowledge regarding the overall power management of the SoC. However, if a complex interface and a power controller with a complicated structure are included in each power domain, it makes the design of the block assigned to each designer more difficult.

The proposed structure is efficient because all parts that require domain expertise in power management are clustered in the main PMU, and only the minimal portions required to physically transmit power control signals are left within each block, so each block designer does not need to care about power management within their own block, and the person in charge of overall power management of the SoC only needs to focus on the main PMU located in the AON region.

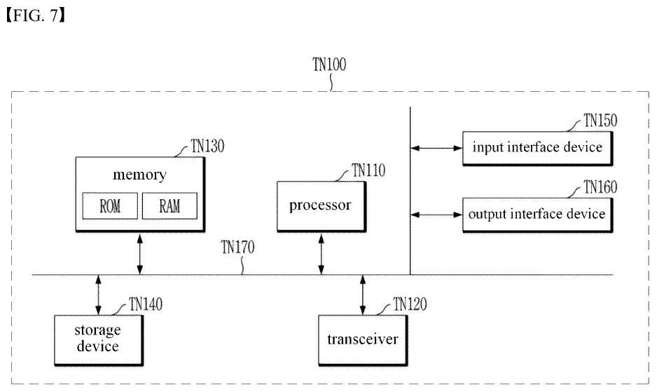

FIG. 7 is a diagram illustrating a computing device according to an embodiment of the present disclosure. The computing device TN100 of FIG. 7 may be the system-on-chip device 300 described in the present specification.

In the embodiment of FIG. 7, the computing device TN100 may include at least one processor TN110, a transceiver TN120, and a memory TN130. The computing device TN100 may further include a storage device TN140, an input interface device TN150, and an output interface device TN160. The components included in the computing device TN100 may be connected to each other via a bus TN170 to perform communication with one another.

The processor TN110 may execute program commands stored in at least one of the memory TN130 and the storage device TN140. The processor TN110 may refer to a central processing unit (CPU), a graphics processing unit (GPU), or a dedicated processor on which the methods according to embodiments of the present disclosure are performed. The processor TN110 may be configured to implement procedures, functions, and methods described in connection with embodiments of the present disclosure. The processor TN110 may control each component of the computing device TN100.

The memory TN130 and the storage device TN140 may each store various information related to the operation of the processor TN110. Each of the memory TN130 and the storage device TN140 may be configured to include at least one of a volatile storage medium and a non-volatile storage medium. For example, the memory TN130 may be configured with at least one of read-only memory (ROM) and random access memory (RAM).

The transceiver TN120 may transmit or receive wired or wireless signals. The transceiver TN120 may be connected to a network and perform communication.

Meanwhile, the embodiments of the present disclosure are not limited to being implemented only through the above-described devices and/or methods but may also be implemented through a program that realizes the functions corresponding to the configurations of the embodiments or a recording medium on which the program is recorded, and such implementations can be easily realized by those skilled in the art based on the description of the above embodiments.

While the embodiments of the present disclosure have been described in detail above, the scope of the present disclosure is not limited thereto, and various modifications and improvements made by those skilled in the art based on the basic concepts of the present disclosure as defined in the following claims also fall within the scope of the present disclosure.

1. A system-on-chip (SoC) device comprising:
at least one power domain; and
at least one power management unit (PMU) respectively corresponding to and controlling the at least one power domain,
wherein the power management unit comprises a first region configured to perform processing and control, and a second region configured to physically transmit signals, wherein the first region and the second region are independently separated and respectively present in different components of the system-on-chip device.

2. The system-on-chip device of claim 1,
wherein at least one first region is respectively present corresponding to each of the at least one power management unit,
and the at least one first region is present in a clustered form within a specific region of the system-on-chip device, excluding the at least one power domain.

3. The system-on-chip device of claim 2, further comprising:
a first power domain that remains active when the system-on-chip device is operating,
wherein the at least one power domain is a second power domain that is selectively activatable when the system-on-chip device is operating,
and wherein the at least one first region is present in a clustered form within the first power domain.

4. The system-on-chip device of claim 3,
wherein the first power domain further comprises a power system manager (PSM), an internal bus, test logic, and memory.

5. The system-on-chip device of claim 1,
wherein at least one second region is present respectively corresponding to each of the at least one power management unit, and
wherein the at least one second region is respectively present corresponding to a non-power gating region of the at least one power domain within the system-on-chip device.

6. The system-on-chip device of claim 1,
wherein the first region is a power domain manager (PDM), which is a microcontroller unit (MCU) configured to control the corresponding power domain, and
the second region is a power operating unit (POU).

7. The system-on-chip device of claim 1, further comprising:
a plurality of sub-system-on-chip devices hierarchically existing at a lower level,
wherein each of the plurality of sub-system-on-chip devices includes a plurality of power domains,
wherein a plurality of first regions respectively corresponding to and controlling the plurality of power domains are present in a clustered form within specific regions excluding the plurality of power domains in each of the plurality of sub-system-on-chip devices, and the plurality of first regions in a clustered form are respectively present corresponding to each of the plurality of sub-system-on-chip devices.

8. The system-on-chip device of claim 1, further comprising:
a memory,
wherein at least one first region is respectively present corresponding to each of the at least one power management unit, and
wherein the memory is partitioned according to addresses and allocates independent address regions corresponding to each of the at least one first region.

9. The system-on-chip device of claim 8,
wherein when a program to be executed by the at least one first region is the same, the program is shared and used in a predetermined address region of the memory.
